(19) United States
(12) Patent Application Publication
(10) Pub. No.: US 2025/0184100 A1
(43) Pub. Date: Jun. 5, 2025

(54) SIGNAL QUALITY MEASUREMENT REPORTING BASED ON DEMODULATION REFERENCE SIGNALS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/839,227

(22) PCT Filed: Apr. 29, 2022
(86) PCT No.: PCT/CN2022/090273

§ 371 Date: Aug. 16, 2024

(51) Int. Cl. H04L 5/00; H04B 7/06; H04W 72/232

(52) U.S. Cl. CPC H04L 5/0094; H04B 7/0626; H04B 7/06968; H04W 72/232

(57) ABSTRACT

Various aspects of the present disclosure generally relate to wireless communication. In some aspects, a user equipment (UE) may receive, via a control resource set (CORESET), a physical downlink control channel (PDCCH) transmission including a demodulation reference signal (DMRS). The UE may transmit data indicating a signal quality difference between a first signal quality measurement associated with the DMRS and a most recent signal quality measurement associated with the CORESET. Numerous other aspects are described.

### FIELD OF THE DISCLOSURE

Aspects of the present disclosure generally relate to wireless communication and to techniques and apparatuses for signal quality measurement reporting based on demodulation reference signals.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, via a control resource set (CORESET), a physical downlink control channel (PDCCH) transmission including a demodulation reference signal (DMRS). The method may include transmitting data indicating a signal quality difference between a first signal quality measurement associated with the DMRS and a most recent signal quality measurement associated with the CORESET.

Some aspects described herein relate to a method of wireless communication performed by a network entity. The method may include transmitting, via a CORESET, a PDCCH transmission including a DMRS. The method may include receiving data indicating a signal quality difference between a first signal quality measurement associated with the DMRS and a most recent signal quality measurement associated with the CORESET.

Some aspects described herein relate to a UE for wireless communication. The user equipment may include a memory and one or more processors coupled to the memory. The one or more processors may be configured to receive, via a CORESET, a PDCCH transmission including a DMRS. The one or more processors may be configured to transmit data indicating a signal quality difference between a first signal quality measurement associated with the DMRS and a most recent signal quality measurement associated with the CORESET.

Some aspects described herein relate to a network entity for wireless communication. The network entity may include a memory and one or more processors coupled to the memory. The one or more processors may be configured to transmit, via a CORESET, a PDCCH transmission including a DMRS. The one or more processors may be configured to receive data indicating a signal quality difference between a first signal quality measurement associated with the DMRS and a most recent signal quality measurement associated with the CORESET.

Some aspects described herein relate to a non-transitory computer-readable medium that stores a set of instructions for wireless communication by a UE. The set of instructions, when executed by one or more processors of the UE, may cause the UE to receive, via a CORESET, a PDCCH transmission including a DMRS. The set of instructions, when executed by one or more processors of the UE, may cause the UE to transmit data indicating a signal quality difference between a first signal quality measurement associated with the DMRS and a most recent signal quality measurement associated with the CORESET.

Some aspects described herein relate to a non-transitory computer-readable medium that stores a set of instructions for wireless communication by a network entity. The set of instructions, when executed by one or more processors of the network entity, may cause the network entity to transmit, via a CORESET, a PDCCH transmission including a DMRS. The set of instructions, when executed by one or more processors of the network entity, may cause the network entity to receive data indicating a signal quality difference between a first signal quality measurement associated with the DMRS and a most recent signal quality measurement associated with the CORESET.

Some aspects described herein relate to an apparatus for wireless communication. The apparatus may include means for receiving, via a CORESET, a PDCCH transmission including a DMRS. The apparatus may include means for transmitting data indicating a signal quality difference between a first signal quality measurement associated with the DMRS and a most recent signal quality measurement associated with the CORESET.

Some aspects described herein relate to an apparatus for wireless communication. The apparatus may include means for transmitting, via a CORESET, a PDCCH transmission including a DMRS. The apparatus may include means for receiving data indicating a signal quality difference between a first signal quality measurement associated with the DMRS and a most recent signal quality measurement associated with the CORESET.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network (O-RAN) architecture, in accordance with the present disclosure.

FIG. 4 is a diagram illustrating an example of a frame structure in a wireless communication network, in accordance with the present disclosure.

FIG. 5 is a diagram illustrating an example resource structure for wireless communication, in accordance with the present disclosure.

FIG. 6 is a diagram illustrating an example of physical channels and reference signals in a wireless network, in accordance with the present disclosure.

FIG. 7 is a diagram illustrating examples of channel state information reference signal (CSI-RS) beam management procedures, in accordance with the present disclosure.

FIG. 8 is a diagram of an example associated with signal quality measurement reporting based on demodulation reference signals (DMRSs), in accordance with the present disclosure.

FIG. 9 is a diagram illustrating examples of configurations associated with reporting a signal quality difference, in accordance with the present disclosure.

FIGS. 10-11 are diagrams illustrating example processes associated with signal quality measurement reporting based on DMRSs, in accordance with the present disclosure.

FIGS. 12-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

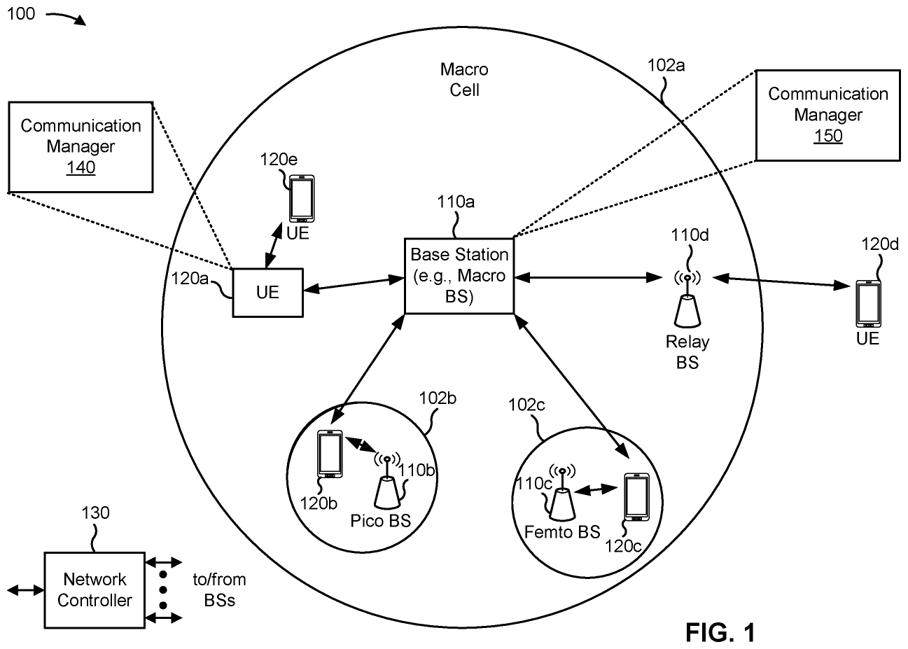

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). It should be understood that although a portion of FRI is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, via a CORESET, a PDCCH transmission including a DMRS; and transmit data indicating a signal quality difference between a first signal quality measurement associated with the DMRS and a most recent signal quality measurement associated with the CORESET. Additionally, or alternatively, the communication manager 140 may perform one or more other operations described herein.

In some aspects, the network entity (e.g., base station 110) may include a communication manager 150. As described in more detail elsewhere herein, the communication manager 150 may transmit, via a CORESET, a PDCCH transmission including a DMRS; and receive data indicating a signal quality difference between a first signal quality measurement associated with the DMRS and a most recent signal quality measurement associated with the CORESET. Additionally, or alternatively, the communication manager 150 may perform one or more other operations described herein.

As indicated above, FIG. 1 is provided as an example. Other examples may differ from what is described with regard to FIG. 1.

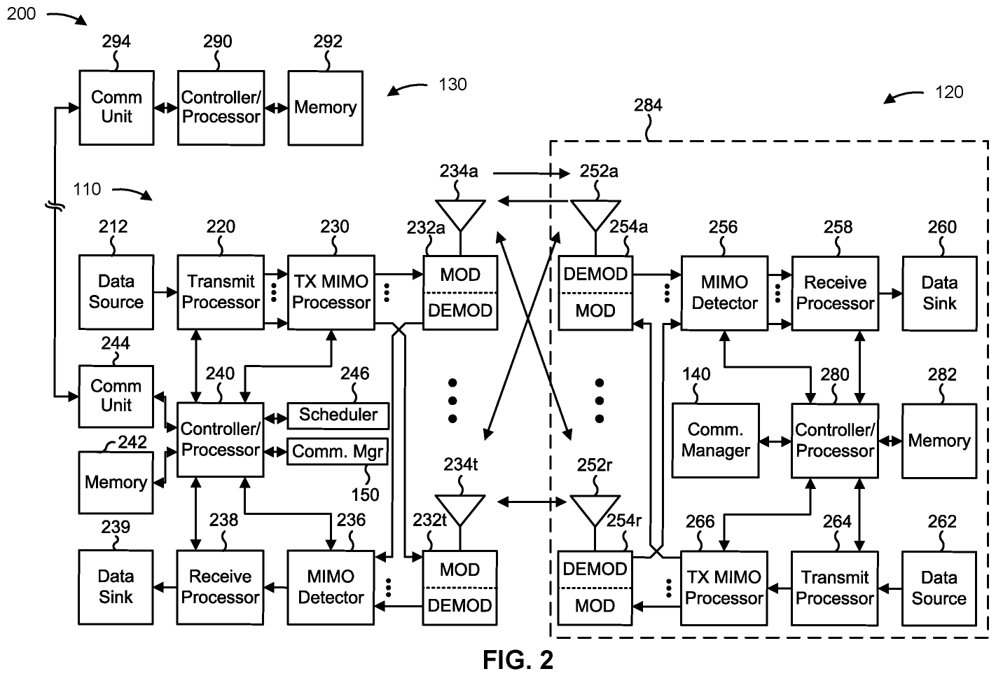

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

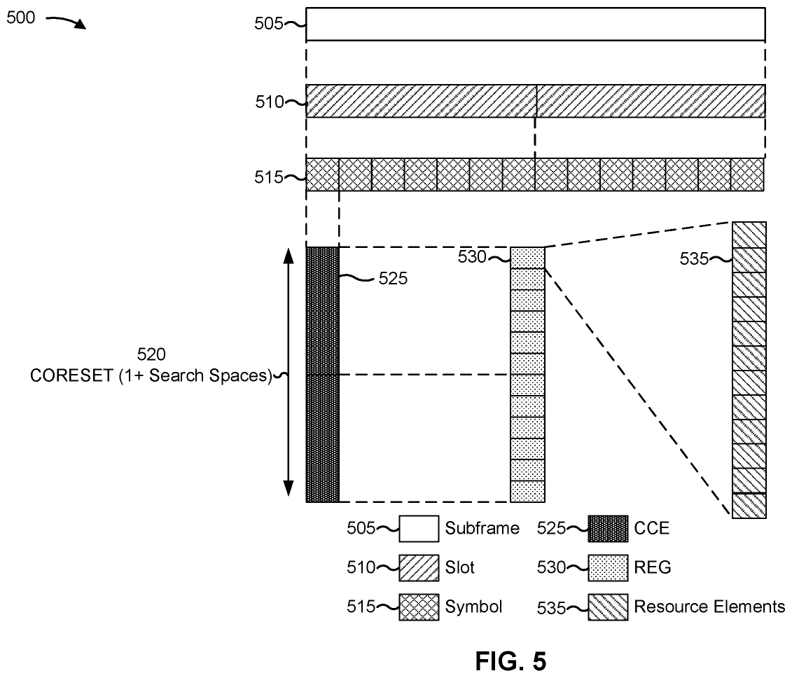

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-13).

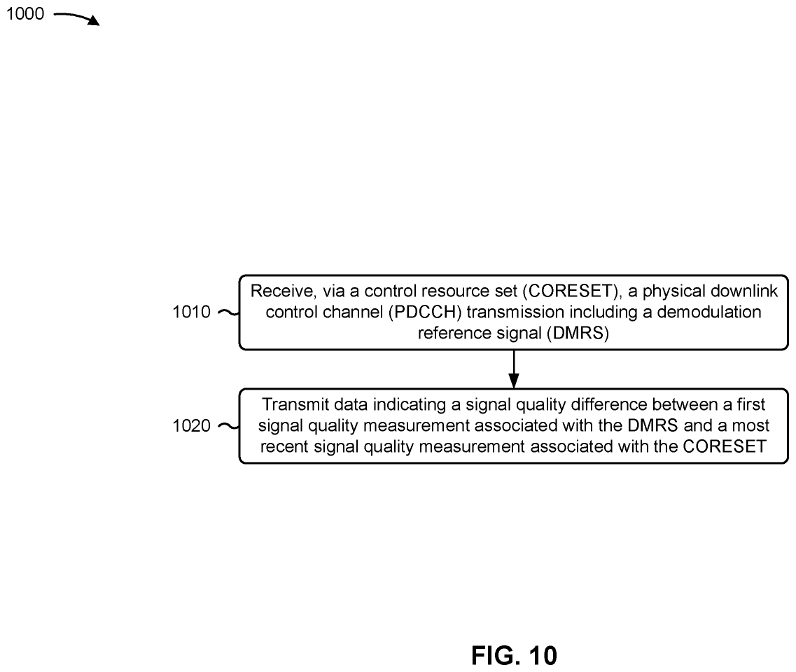

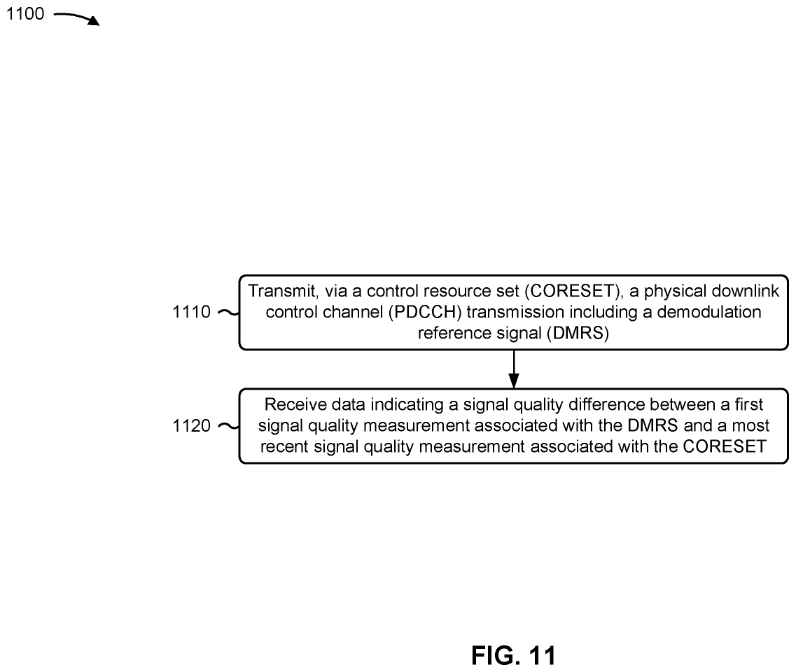

The controller/processor 240 of the base station 110, the controller/processor 280 of the UE 120, and/or any other component(s) of FIG. 2 may perform one or more techniques associated with signal quality measurement reporting based on DMRSs, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, via a CORESET, a PDCCH transmission including a DMRS; and/or means for transmitting data indicating a signal quality difference between a first signal quality measurement associated with the DMRS and a most recent signal quality measurement associated with the CORESET. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., the base station 110) includes means for transmitting, via a CORESET, a PDCCH transmission including a DMRS; and/or means for receiving data indicating a signal quality difference between a first signal quality measurement associated with the DMRS and a most recent signal quality measurement associated with the CORESET. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

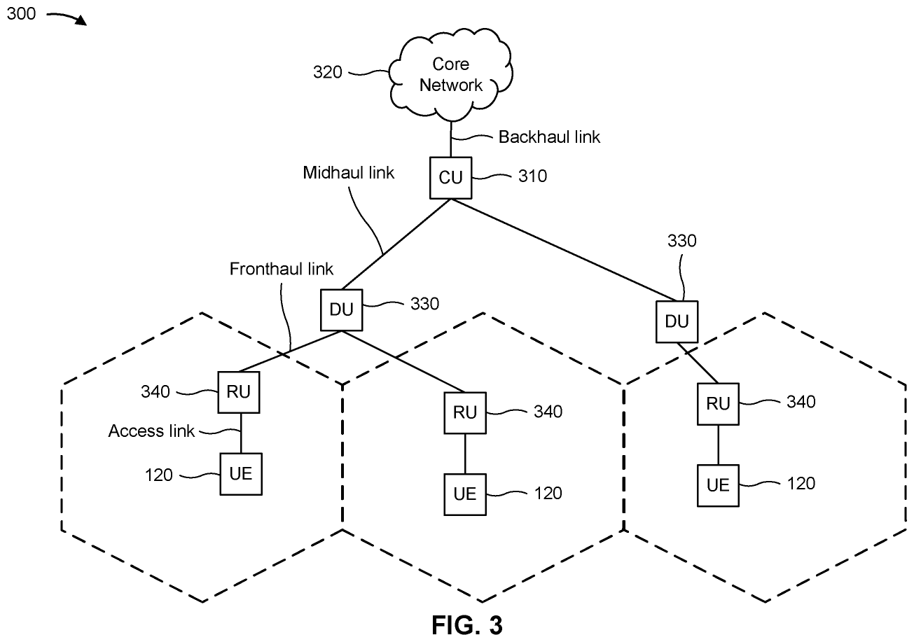

FIG. 3 is a diagram illustrating an example 300 of an O-RAN architecture, in accordance with the present disclosure. As shown in FIG. 3, the O-RAN architecture may include a centralized unit (CU) 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via radio frequency (RF) access links. The DUs 330 and the RUs 340 may also be referred to as O-RAN DUs (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

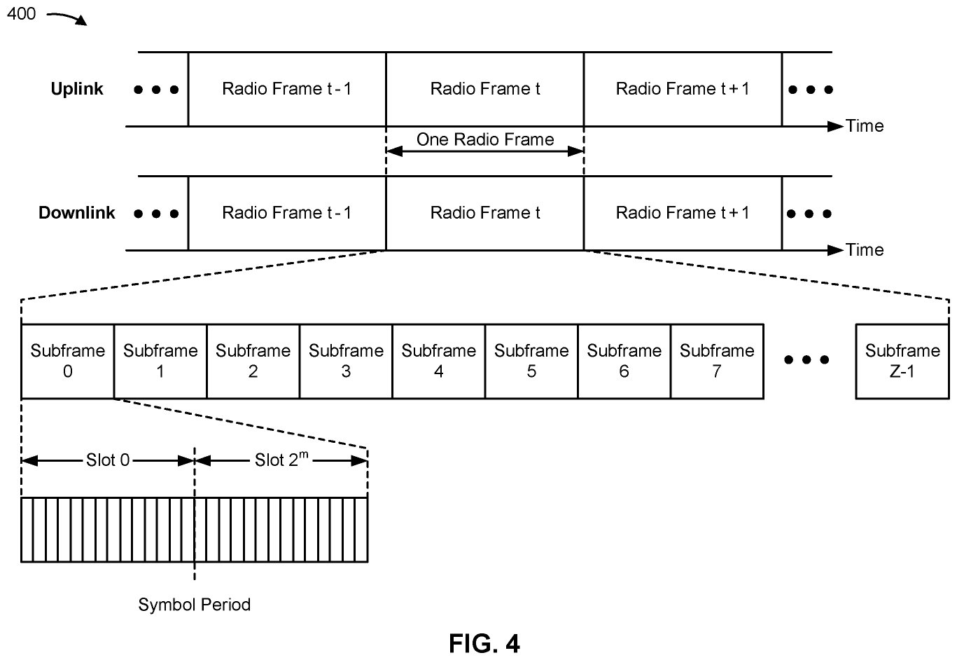

FIG. 4 is a diagram illustrating an example 400 of a frame structure in a

wireless communication network, in accordance with the present disclosure. The frame structure shown in FIG. 4 is for frequency division duplexing (FDD) in a telecommunication system, such as LTE or NR. The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z-1). Each subframe may have a predetermined duration (e.g., 1 ms) and may include a set of slots (e.g., 2m slots per subframe are shown in FIG. 4, where m is an index of a numerology used for a transmission, such as 0, 1, 2, 3, 4, or another number). Each slot may include a set of L symbol periods. For example, each slot may include fourteen symbol periods (e.g., as shown in FIG. 4), seven symbol periods, or another number of symbol periods. In a case where the subframe includes two slots (e.g., when m=1), the subframe may include 2L symbol periods, where the 2L symbol periods in each subframe may be assigned indices of 0 through 2L-1. In some aspects, a scheduling unit for the FDD may be frame-based, subframe-based, slot-based, mini-slot based, or symbol-based.

As indicated above, FIG. 4 is provided as an example. Other examples may differ from what is described with respect to FIG. 4.

FIG. 5 is a diagram illustrating an example resource structure 500 for wireless communication, in accordance with the present disclosure. Resource structure 500 shows an example of various groups of resources described herein. As shown, resource structure 500 may include a subframe 505. Subframe 505 may include multiple slots 510. While resource structure 500 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 510 may include multiple symbols 515, such as 14 symbols per slot.

The potential control region of a slot 510 may be referred to as a control resource set (CORESET) 520 and may be structured to support an efficient use of resources, such as by flexible configuration or reconfiguration of resources of the CORESET 520 for one or more physical downlink control channels (PDCCHs) and/or one or more physical downlink shared channels (PDSCHs). In some aspects, the CORESET 520 may occupy the first symbol 515 of a slot 510, the first two symbols 515 of a slot 510, or the first three symbols 515 of a slot 510. Thus, a CORESET 520 may include multiple resource blocks (RBs) in the frequency domain, and either one, two, or three symbols 515 in the time domain. In 5G, a quantity of resources included in the CORESET 520 may be flexibly configured, such as by using radio resource control (RRC) signaling to indicate a frequency domain region (e.g., a quantity of resource blocks) and/or a time domain region (e.g., a quantity of symbols) for the CORESET 520.

As illustrated, a symbol 515 that includes CORESET 520 may include one or more control channel elements (CCEs) 525, shown as two CCEs 525 as an example, that span a portion of the system bandwidth. A CCE 525 may include downlink control information (DCI) that is used to provide control information for wireless communication, such as one or more reference signals, as described herein. A network entity (e.g., base station 110) may transmit DCI during multiple CCEs 525 (as shown), where the quantity of CCEs 525 used for transmission of DCI represents the aggregation level (AL) used by the network entity for the transmission of DCI. In FIG. 5, an aggregation level of two is shown as an example, corresponding to two CCEs 525 in a slot 510. In some aspects, different aggregation levels may be used, such as 1, 2, 4, 8, 16, or another aggregation level.

Each CCE 525 may include a fixed quantity of resource element groups (REGs) 530, shown as 6 REGs 530, or may include a variable quantity of REGs 530. In some aspects, the quantity of REGs 530 included in a CCE 525 may be specified by a REG bundle size. A REG 530 may include one resource block, which may include 12 resource elements (REs) 535 within a symbol 515. A resource element 535 may occupy one subcarrier in the frequency domain and one OFDM symbol in the time domain.

A search space may include all possible locations (e.g., in time and/or frequency) where a PDCCH may be located. A CORESET 520 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 520 may be interleaved or non-interleaved. An interleaved CORESET 520 may have CCE-to-REG mapping such that adjacent CCEs are mapped to scattered REG bundles in the frequency domain (e.g., adjacent CCEs are not mapped to consecutive REG bundles of the CORESET 520). A non-interleaved CORESET 520 may have a CCE-to-REG mapping such that all CCEs are mapped to consecutive REG bundles (e.g., in the frequency domain) of the CORESET 520.

As indicated above, FIG. 5 is provided as an example. Other examples may differ from what is described with respect to FIG. 5.

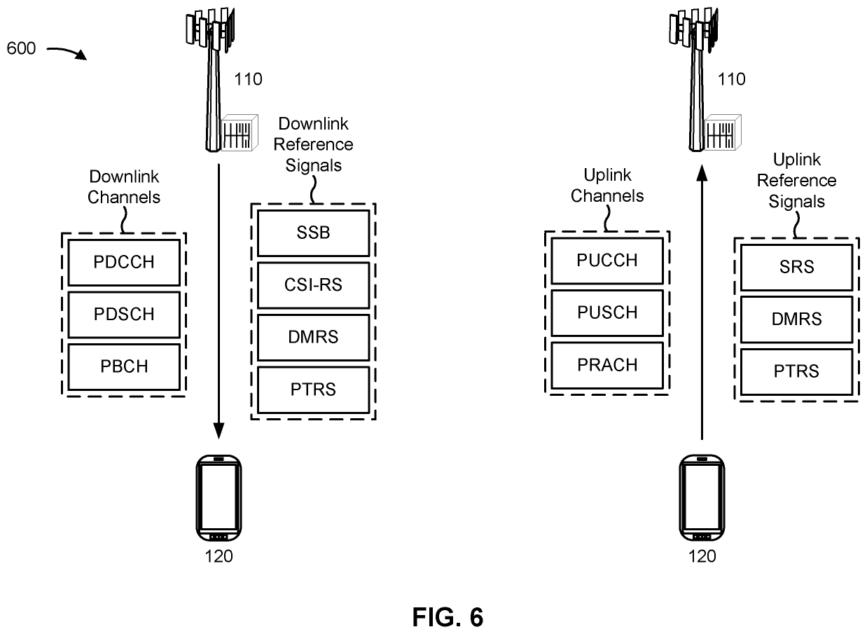

FIG. 6 is a diagram illustrating an example 600 of physical channels and reference signals in a wireless network, in accordance with the present disclosure. As shown in FIG. 6, downlink channels and downlink reference signals may carry information from a network entity (e.g., base station 110) to a UE 120, and uplink channels and uplink reference signals may carry information from a UE 120 to a network entity (e.g., base station 110). In some aspects, as described herein, at least a portion of the information may be included in a CORESET.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI- RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The base station 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 6 is provided as an example. Other examples may differ from what is described with regard to FIG. 6.

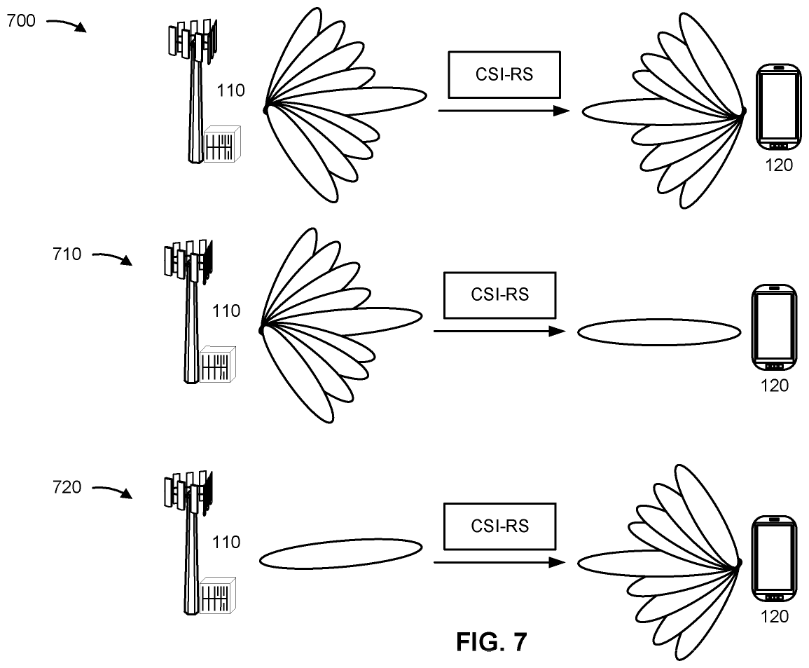

FIG. 7 is a diagram illustrating examples 700, 710, and 720 of CSI-RS beam management procedures, in accordance with the present disclosure. As shown in FIG. 7, examples 700, 710, and 720 include a UE 120 in communication with a network entity (e.g., base station 110) in a wireless network (e.g., wireless network 100). However, the devices shown in FIG. 7 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). In some aspects, the UE 120 and the base station 110 may be in a connected state (e.g., an RRC connected state).

As shown in FIG. 7, example 700 may include a base station 110 and a UE 120 communicating to perform beam management using CSI-RSs. Example 700 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 7 and example 700, CSI-RSs may be configured to be transmitted from the base station 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 700 has been described in connection with CSI-RSs, the first beam management process may also use SSBs for beam management in a similar manner as described above.

As shown in FIG. 7, example 710 may include a base station 110 and a UE 120 communicating to perform beam management using CSI-RSs. Example 710 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 7 and example 710, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 7, example 720 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 7 and example 720, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

After establishing beams for wireless communication, and due to the uncertain nature of the wireless environment and potential unexpected blocking, beams may be vulnerable to beam failure. Beam failure may be caused by poor channel quality, and/or temporary interference from other beams and/or other radio frequency signals, among other examples.

In addition to the beam management procedures described herein, measurements associated with various reference signals (e.g., signal-to-interference- plus-noise ratio (SINR) measurements, RSRP measurements, and/or the like) may be used to facilitate beam failure detection and/or beam failure recovery processes. For example, in operation, the UE 120 may need to perform a beam failure detection (BFD) measurement associated with the network entity (e.g., base station 110), such that the UE 120 can detect a beam failure associated with the base station). For example, the UE 120 may measure a characteristic (e.g., an SINR, RSRP, and/or the like) of a reference signal (e.g., an SSB, a CSI-RS, and/or the like) on a beam associated with the base station. If the characteristic fails to satisfy a threshold (e.g., if the SINR and/or RSRP is lower than a particular value), then the UE may identify a beam failure instance. In some situations, the UE 120 may detect a beam failure when the number of beam failure instances reaches a configured threshold within a particular period of time (e.g., before a configured timer expires). After the beam failure is detected, the UE 120 may perform a beam failure recovery procedure, which may include performing one or more beam management procedures described herein (e.g., P1, P2, and/or P3).

Some beam management procedures, such as beam prediction procedures, may enable a UE 120 and/or a network entity to predict when a beam failure is likely to occur. However, such procedures often use frequent reporting of reference signals to make predictions. For example, a UE 120 may measure reference signals periodically (e.g., every 20 ms, 80 ms, and/or the like). The periodic measurements may be used to predict (e.g., with artificial intelligence and/or machine learning models, including neural networks, and/or the like) whether a beam failure might occur and enable corrective action to be taken.

While reference signals enable the UE 120 to perform beam failure prediction, detection, and recovery procedures, the beam management procedures may use significant UE 120 power and communication resources to predict, detect, and recover from beam failure, such as resources for periodically measuring reference signals, beam sweeping, additional reporting, and/or the like. For example, frequently reporting reference signal measurements may incur significant signaling and processing overhead for both UEs and networks. While some predictive solutions may help reduce reference signal measurement reporting frequency, reducing signaling frequency may reduce the accuracy of the predictions, and reference signal measurement overhead is still used. In addition, beam failure recovery procedures may take significant time, processing, and network resources to perform, during which the UE 120 may experience degraded communications capabilities, such as increased latency, decreased throughput, and/or the like.

As indicated above, FIG. 7 is provided as an example of beam management procedures. Other examples of beam management procedures may differ from what is described with respect to FIG. 7. For example, the UE 120 and the base station 110 may perform the third beam management procedure before performing the second beam management procedure, and/or the UE 120 and the base station 110 may perform a similar beam management procedure to select a UE transmit beam.

Some techniques and apparatuses described herein enable reporting of signal quality measurements based on DMRSs associated with PDCCH transmissions. For example, a UE may receive, via a CORESET, a PDCCH transmission that includes a DMRS. Based on a comparison between the signal quality of the DMRS and a prior signal quality measurement associated with the CORESET, the UE may determine a signal quality difference. The signal quality difference may be transmitted to a network entity, where the signal quality difference may be used to determine whether one or more beam management procedures should be performed. As a result, the signal quality difference can be used in place of other reference signals (e.g., separate SSB and/or CSI-RS signaling) to determine when to perform beam management procedures. This may reduce the usage of resources that might otherwise be used to frequently communicate and process SSBs, CSI-RSs, and/or the like for beam management (e.g., including beam failure prediction, detection, and/or recovery procedures). In this way, resources, including power, communication, and/or processing resources, may be conserved by UEs and/or network entities that use reference signals to facilitate beam management procedures.

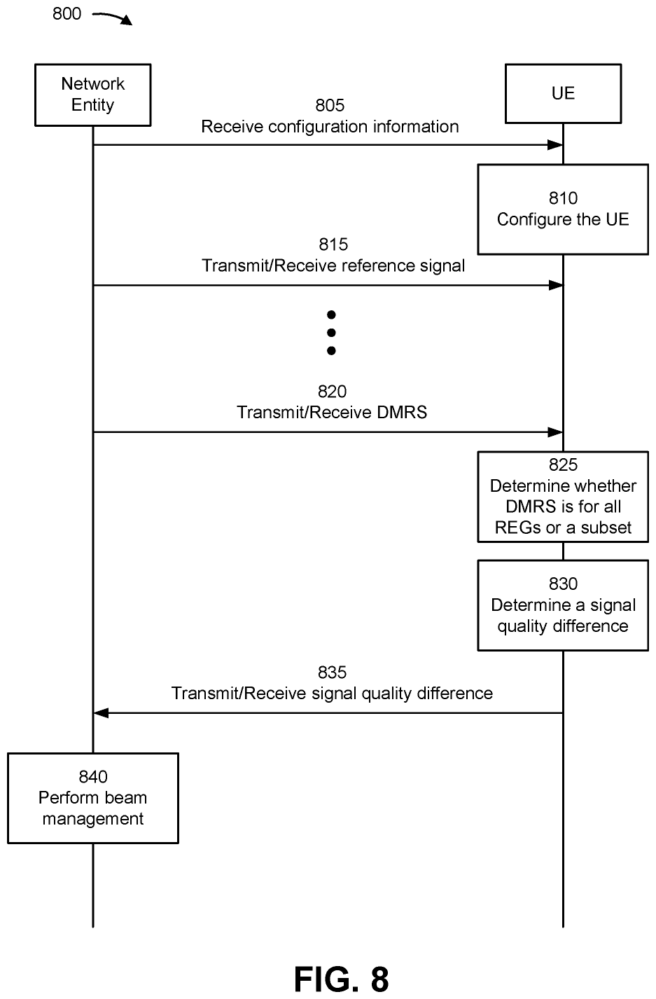

FIG. 8 is a diagram of an example 800 associated with signal quality measurement reporting based on demodulation reference signals, in accordance with the present disclosure. As shown in FIG. 8, a network entity (e.g., base station 110) may communicate with a UE (e.g., UE 120). In some aspects, the network entity and the UE may be part of a wireless network (e.g., wireless network 100). The UE and the network entity may have established a wireless connection prior to operations shown in FIG. 8.

As shown by reference number 805, the base station may transmit, and the UE may receive, configuration information. In some aspects, the UE may receive the configuration information via one or more of radio resource control (RRC) signaling, one or more medium access control (MAC) control elements (CEs), and/or downlink control information (DCI), among other examples. In some aspects, the configuration information may include an indication of one or more configuration parameters (e.g., already known to the UE and/or previously indicated by the base station or other network device) for selection by the UE, and/or explicit configuration information for the UE to use to configure the UE, among other examples.

In some aspects, the configuration information may indicate that the UE is to determine a signal quality difference between a first signal quality measurement and a most recent signal quality measurement, and to transmit information indicating the signal quality difference to the network entity. The first signal quality measurement may be associated with a DMRS included in a PDCCH received via a CORESET, and the most recent signal quality measurement may be associated with the CORESET (e.g., an L1 RSRP, CQI, and/or SINR of a type-D quasi co-located reference signal of the CORESET).

As shown by reference number 810, the UE may configure itself based at least in part on the configuration information. In some aspects, the UE may be configured to perform one or more operations described herein based at least in part on the configuration information.

As shown by reference number 815, the network entity may transmit, and the UE may receive, a reference signal. For example, the network entity may transmit, and the UE may receive, a CSI-RS, a DMRS, a PTRS, and/or the like. In some aspects, the reference signal may be received via a PDCCH transmission, a PDSCH transmission, and/or the like. The UE may use the reference signal to determine a signal quality measurement associated with the reference signal, such as an RSRP value, a CQI value, an SINR value, and/or the like. In some aspects, the reference signal may be associated with a CORESET (e.g., transmitted via the CORESET). The aforementioned signal quality measurement may be referred to herein as a “most recent signal quality measurement,” as, for the purposes of determining a signal quality difference, the signal quality measurement may be the most recent signal quality measurement associated with the CORESET (e.g., the most recent signal quality measurement for a reference signal that is type-D quasi co-located with the CORESET described in association with reference number 820).

As shown by reference number 820, the network entity may transmit, and the UE may receive, a DMRS. For example, the DMRS may be included in a PDCCH transmission transmitted via the CORESET. In some aspects, the DMRS may correspond to both PDCCH resources and non-PDCCH resources of the CORESET. For example, the PDCCH may only use a portion of the REGs of the CORESET, and the DMRS may be for only the portion that includes the PDCCH, or the DMRS may be for the entire CORESET.

In some aspects, the DMRS may be received in association with a DCI included in the PDCCH. The DCI may include information that the UE may use to determine whether the UE should report a signal quality difference that can be used for beam management. For example, the DCI may include an uplink grant, which may enable the UE to include data indicating a signal quality difference in a CSI report using PUSCH resources scheduled by the DCI. In a situation where the DCI includes a downlink grant, an enhanced CSI triggering list may be used to identify uplink resources that the UE may use to report the signal quality difference. As another example, sending data indicating the signal quality difference may be triggered using an access point CSI triggering list, where the CSI triggering state may identify an enhanced CSI report setting for providing the signal quality difference, as described further herein.

As shown by reference number 825, the UE may determine whether the DMRS is for all REGs, or only a subset of the REGs of the CORESET. In some aspects, the UE may make the determination based on DCI included in the PDCCH. For example, the UE may determine whether the DMRS is for all REGs within the CORESET, or a subset of the REGs associated with the PDCCH, based at least in part on an aggregation level associated with the PDCCH, a precoding associated with the REGs, and/or a specific indication included in the DCI. For example, if the same precoding is applied to all REGs within the CORESET (e.g., precoderGranularity=allContiguousRBs for the associated CORESET), and/or an indication, included in the DCI, specifies that the DMRS is for both the PDCCH resources and the non-PDCCH resources, the UE may determine that the DMRS is for all REGs within the CORESET. Otherwise, the UE may determine that the DMRS is for only the REGs of the PDCCH. As another example, if an aggregation level associated with the PDCCH satisfies an aggregation threshold, and/or an indication, included in the DCI, specifies that the DMRS is for a subset of the CORESET resources (e.g., the PDCCH REGs), the UE may determine that the DMRS is for only the REGs of the PDCCH.

As shown by reference number 830, the UE may determine a signal quality difference. The signal quality difference may be a difference between the most recent signal quality measurement and a signal quality measurement associated with the DMRS. In some aspects, the signal quality measurement may be an L1 RSRP, CQI, SINR, and/or the like, associated with the CORESET. As noted herein, the most recent signal quality measurement may be for the most recent type-D quasi co-located source reference signal associated with the CORESET.

In some aspects, the DMRS associated with the first signal quality measurement is for a subset of the CORESET resources that includes REGs that correspond to the PDCCH. In other words, the DMRS may be for the REGs of the PDCCH, rather than the CORESET as a whole. In some aspects, the DMRS associated with the first signal quality measurement is for all of the REGs of the CORESET. In some aspects, the UE may determine the signal quality difference based on determining whether the DMRS is for all REGs of the CORESET or a subset of the REGs of the CORESET, as described in association with reference number 825.

In some aspects, the most recent signal quality measurement may be based at least in part on a virtual number of REs of the most recent resource associated with the most recent signal quality measurement. For example, the most recent DMRS-based RSRP measurement (e.g., used for comparison with the first RSRP measurement) may be reported based on a virtual number of REs of a CSI-RS/SSB resource associated with the most recently reported RSRP. In some aspects, the signal quality difference may also be based at least in part on DMRS power boosting, where the signal quality difference may be determined based at least in part on whether DMRS power boosting is used.

As shown by reference number 835, the UE may transmit, and the network entity may receive, data indicating the signal quality difference between the signal quality measurement associated with the DMRS and a most recent signal quality measurement associated with the CORESET. In some aspects, the data may be transmitted in a MAC-CE or CSI report. In some aspects, the data may be transmitted based at least in part on DCI included in the PDCCH that included the DMRS. For example, the UE may transmit the data in a PUSCH transmission scheduled by the DCI.

In some aspects, the UE may identify, based at least in part on the DCI including a downlink grant and using an enhanced CSI triggering list, uplink resources for transmission of the data. In some aspects, the UE may be configured with a CSI triggering state that identifies an enhanced CSI report setting that allows the data indicating the signal quality difference to be reported to the network entity via an enhanced CSI report.

In some aspects, the UE may determine whether one or more conditions for transmission of the data have been satisfied and, based at least in part on the determination, selectively transmit the data. For example, one condition may include a time interval, or time threshold, between a monitoring occasion of the CORESET and a transmission time for the transmission of the data satisfying a time threshold. This may ensure that the data indicating the difference between signal quality measurements is recent enough to be useful for the network entity. As another example, a condition may include a number of PDCCH transmissions triggering the transmission of the data satisfying a PDCCH threshold indicating a maximum number of PDCCH transmissions within a particular period of time. This may ensure that the UE does not transmit the data indicating the difference between signal quality measurements too often. In some aspects, the time interval (e.g., time threshold), the PDCCH threshold, and/or the particular period of time, may be based at least in part on a predefined standard, a capability of the UE (e.g., a UE specified time interval), and/or a type of grant included in the PDCCH (e.g., different types of grants may be associated with different thresholds).

For example, a maximum time interval (e.g., time threshold) between the first symbol or last symbol of the CORESET carrying DCI that triggers transmission of the data, and the first symbol of a PUSCH carrying the data, may be predefined (e.g., in a standard), such as a 1 ms maximum time interval. A UE may report the time interval for itself (e.g., based on its capabilities). As another example, the UE may report that the time interval is based at least in part on subcarrier spacing (e.g., the time interval should not be lower than one symbol for 120 kHz subcarrier spacing, and/or 2 symbols for 240 kHz subcarrier spacing, among other examples). In addition, within a particular period of time, a maximum (e.g., threshold) number of total PDCCH candidates that may include DCI triggering transmission of the data indicating the difference between signal quality measurements may also be preconfigured (e.g., based on a standard) and/or based on UE capability. In some situations, the threshold number may be based on the type of grant, such that the threshold number may be different for uplink grants and downlink grants. In some aspects, time durations associated with the conditions for transmitting the data may be defined by a number of slots, symbols, subframes, and/or the like.

In some aspects, the capabilities of the UE, with respect to the conditions for transmitting the data indicating the signal quality difference, may be transmitted jointly for all conditions in one report, or may be separated into different conditions (e.g., associated with UE capabilities) in separate transmissions. For example, a UE may report that the maximum number of PDCCH candidates that can include a triggering DCI within a particular time period, along with the minimum time interval between the first or last symbol of the CORESET and the first symbol of the PUSCH carrying the data.

As shown by reference number 840, the network entity may selectively perform one or more beam management procedures based at least in part on the signal quality difference. For example, the network entity may perform a beam refinement procedure, or any other beam management procedures described herein, based at least in part on the signal quality difference satisfying a difference threshold. The signal quality difference may indicate, to the network entity, how much the signal quality has changed since the most recent type-D quasi co-located reference signal, and this may trigger one or more beam management procedures (e.g., to improve signal quality between the network entity and the UE).

In this way, the signal quality difference can be used instead of other reference signals (e.g., separate SSB and/or CSI-RS signaling) to determine when to perform beam management procedures. This may reduce the usage of network and/or processing resources that might otherwise be used to frequently communicate and process SSBs, CSI-RSs, and/or the like for beam management (e.g., including beam failure prediction, detection, and/or recovery procedures). In this way, resources, including power, network, and/or processing resources may be conserved by UEs and/or network entities that use reference signals to facilitate beam management procedures.

As indicated above, FIG. 8 is provided as an example. Other examples may differ from what is described with respect to FIG. 8.

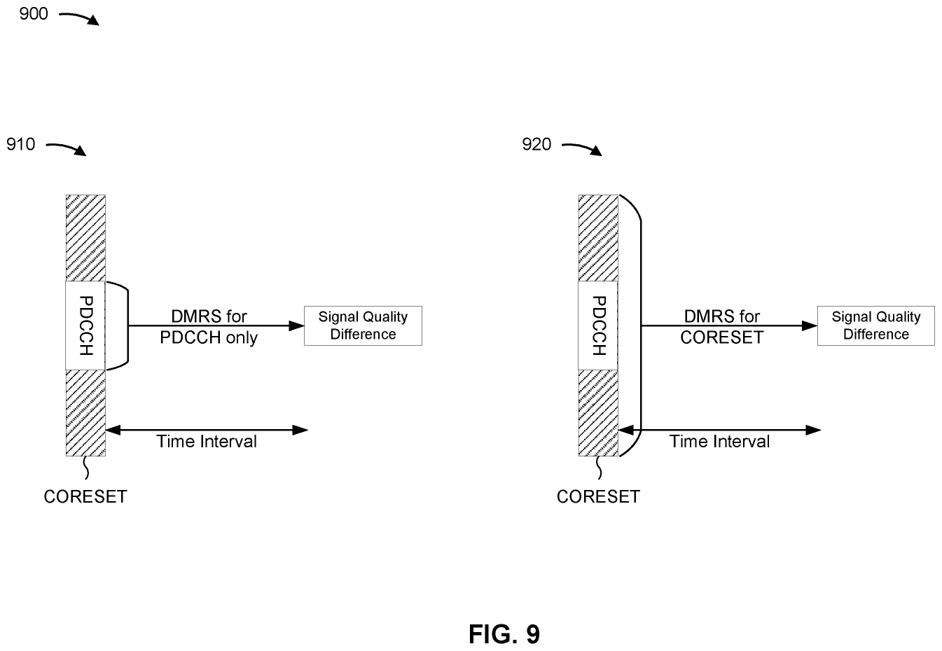

FIG. 9 is a diagram illustrating examples 900 of configurations associated with reporting a signal quality difference, in accordance with the present disclosure. As shown in FIG. 9, a first example 910 depicts a situation where the DMRS is for the PDCCH only, rather than the entire CORESET. Further, a second example 920 depicts a situation where the DMRS is for the entire CORESET. In addition, the examples 900 indicate a time interval between the CORESET and transmission of the data indicating the signal quality difference. This time interval, as discussed further herein, may be used as a condition for transmitting the data indicating the signal quality difference (e.g., the data may only be transmitted within the time interval), and the time interval may be configured in a variety of ways (e.g., preconfigured by the network entity, based on UE capability, and/or the like).

As indicated above, FIG. 9 is provided to illustrate examples. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 120) performs operations associated with signal quality measurement reporting based on DMRSs.

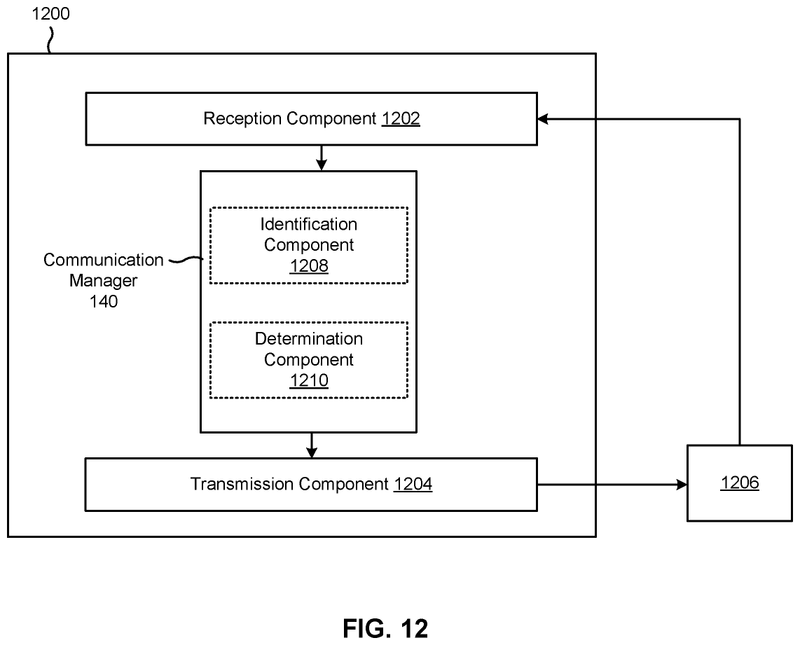

As shown in FIG. 10, in some aspects, process 1000 may include receiving, via a CORESET, a PDCCH transmission including a DMRS (block 1010). For example, the UE (e.g., using communication manager 140 and/or reception component 1202, depicted in FIG. 12) may receive, via a CORESET, a PDCCH transmission including a DMRS, as described above.

As further shown in FIG. 10, in some aspects, process 1000 may include transmitting data indicating a signal quality difference between a first signal quality measurement associated with the DMRS and a most recent signal quality measurement associated with the CORESET (block 1020). For example, the UE (e.g., using communication manager 140 and/or transmission component 1204, depicted in FIG. 12) may transmit data indicating a signal quality difference between a first signal quality measurement associated with the DMRS and a most recent signal quality measurement associated with the CORESET, as described above.

Process 1000 may include additional aspects, such as any single aspect or any combination of aspects described below and/or in connection with one or more other processes described elsewhere herein.

In a first aspect, the most recent signal quality measurement is for a most recent type-D quasi co-located source reference signal associated with the CORESET.

In a second aspect, alone or in combination with the first aspect, transmitting the data comprises transmitting the data based at least in part on DCI included in the PDCCH.

In a third aspect, alone or in combination with one or more of the first and second aspects, transmitting the data comprises transmitting the data in a PUSCH transmission scheduled by the DCI.

In a fourth aspect, alone or in combination with one or more of the first through third aspects, process 1000 includes identifying, based at least in part on the DCI including a downlink grant and using an enhanced CSI triggering list, uplink resources, and transmitting the data comprises transmitting the data using the uplink resources.

In a fifth aspect, alone or in combination with one or more of the first through fourth aspects, transmitting the data comprises transmitting the data based at least in part on an enhanced CSI report setting associated with an aperiodic CSI triggering list.

In a sixth aspect, alone or in combination with one or more of the first through fifth aspects, the DMRS associated with the first signal quality measurement is for a subset of the CORESET resources that includes resource element groups that correspond to the PDCCH.

In a seventh aspect, alone or in combination with one or more of the first through sixth aspects, process 1000 includes determining, based on DCI included in the PDCCH, that the DMRS is for the subset of the CORESET resources.

In an eighth aspect, alone or in combination with one or more of the first through seventh aspects, the determination is based at least in part on at least one of an aggregation level associated with the PDCCH satisfying an aggregation threshold, or an indication, included in the DCI, specifying that the DMRS is for the subset of the CORESET resources.

In a ninth aspect, alone or in combination with one or more of the first through eighth aspects, the DMRS associated with the first signal quality measurement corresponds to both PDCCH resources and non-PDCCH resources of the CORESET.

In a tenth aspect, alone or in combination with one or more of the first through ninth aspects, process 1000 includes determining, based on DCI included in the PDCCH, that the DMRS is for all resource element groups within the CORESET.

In an eleventh aspect, alone or in combination with one or more of the first through tenth aspects, the determination is based at least in part on at least one of a same precoding being applied to all resource element groups within the CORESET, or an indication, included in the DCI, specifying that the DMRS is for both the PDCCH resources and the non-PDCCH resources.

In a twelfth aspect, alone or in combination with one or more of the first through eleventh aspects, process 1000 includes determining that one or more conditions for transmission of the data have been satisfied, and transmitting the data comprises transmitting the data based at least in part on determining that the one or more conditions have been satisfied.

In a thirteenth aspect, alone or in combination with one or more of the first through twelfth aspects, the one or more conditions include at least one of a time interval between a monitoring occasion of the CORESET and a transmission time for the transmission of the data satisfies a time threshold, and a number of PDCCH transmissions triggering the transmission of the data satisfies a threshold number of PDCCH transmissions within a particular period of time.

In a fourteenth aspect, alone or in combination with one or more of the first through thirteenth aspects, at least one of the time interval, the threshold number, or the particular period of time, is based at least in part on at least one of a predefined standard, a capability of the UE, or a type of grant included in the PDCCH.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., base station 110) performs operations associated with signal quality measurement reporting based on DMRSs.

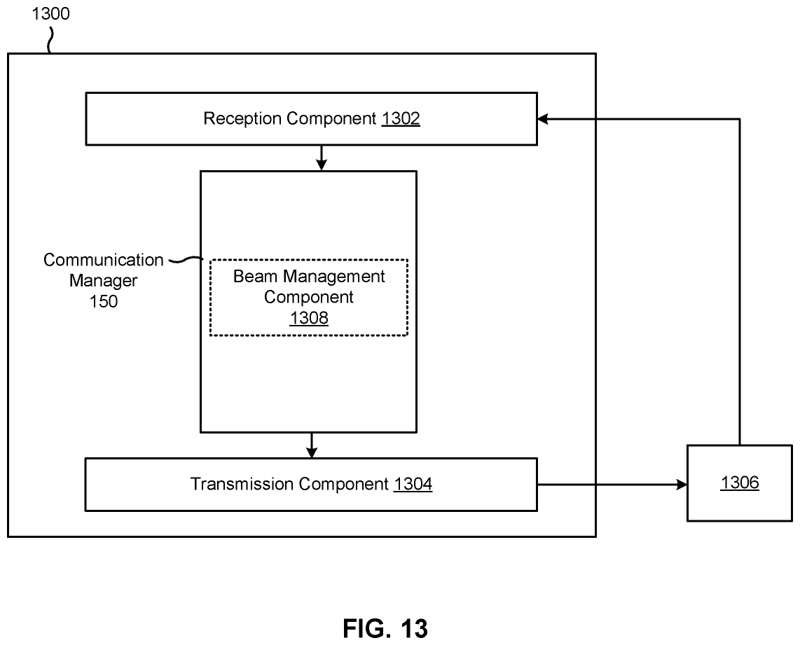

As shown in FIG. 11, in some aspects, process 1100 may include transmitting, via a CORESET, a PDCCH transmission including a DMRS (block 1110). For example, the network entity (e.g., using communication manager 150 and/or transmission component 1304, depicted in FIG. 13) may transmit, via a CORESET, a PDCCH transmission including a DMRS, as described above.

As further shown in FIG. 11, in some aspects, process 1100 may include receiving data indicating a signal quality difference between a first signal quality measurement associated with the DMRS and a most recent signal quality measurement associated with the CORESET (block 1120). For example, the network entity (e.g., using communication manager 150 and/or reception component 1302, depicted in FIG. 13) may receive data indicating a signal quality difference between a first signal quality measurement associated with the DMRS and a most recent signal quality measurement associated with the CORESET, as described above.

Process 1100 may include additional aspects, such as any single aspect or any combination of aspects described below and/or in connection with one or more other processes described elsewhere herein.

In a first aspect, process 1100 includes performing one or more beam refinement procedures based at least in part on the signal quality difference.

In a second aspect, alone or in combination with the first aspect, the PDCCH includes DCI that triggers transmission of the signal quality difference.

In a third aspect, alone or in combination with one or more of the first and second aspects, the DCI includes an uplink grant scheduling a PUSCH transmission, and receiving the data comprises receiving the data in the PUSCH transmission.

In a fourth aspect, alone or in combination with one or more of the first through third aspects, the DCI includes a downlink grant, and receiving the data comprises receiving the data using uplink resources configured for reception of the data.

In a fifth aspect, alone or in combination with one or more of the first through fourth aspects, the DMRS associated with the first signal quality measurement is for a subset of the CORESET resources that includes resource element groups that correspond to the PDCCH.

In a sixth aspect, alone or in combination with one or more of the first through fifth aspects, DCI included in the PDCCH indicates that the DMRS is for a subset of the CORESET resources.

In a seventh aspect, alone or in combination with one or more of the first through sixth aspects, the DCI indicates that the DMRS is for the subset of the CORESET resources based at least in part on at least one of an aggregation level associated with the PDCCH and a preconfigured aggregation threshold, or an indication, included in the DCI, specifying that the DMRS is for the subset of the CORESET resources.

In an eighth aspect, alone or in combination with one or more of the first through seventh aspects, the most recent signal quality measurement is a most recent type-D quasi co-located source reference signal associated with the CORESET.

In a ninth aspect, alone or in combination with one or more of the first through eighth aspects, DCI included in the PDCCH indicates that the DMRS is for all resource element groups within the CORESET.

In a tenth aspect, alone or in combination with one or more of the first through ninth aspects, the DCI indicates that the DMRS is for both the PDCCH resources and the non-PDCCH resources based at least in part on at least one of a same precoding being applied to all resource element groups within the CORESET, or an indication, included in the DCI, specifying that the DMRS is for both the PDCCH resources and the non-PDCCH resources.

In an eleventh aspect, alone or in combination with one or more of the first through tenth aspects, process 1100 includes transmitting configuration information that indicates one or more conditions for transmission of the data.

In a twelfth aspect, alone or in combination with one or more of the first through eleventh aspects, the one or more conditions include at least one of a time interval between a monitoring occasion of the CORESET and a transmission time for the transmission of the data satisfies a time threshold, and a number of PDCCH transmissions triggering the transmission of the data satisfies a threshold number of PDCCH transmissions within a particular period of time.

In a thirteenth aspect, alone or in combination with one or more of the first through twelfth aspects, at least one of the time interval, the threshold number, or the particular period of time, is based at least in part on at least one of a predefined standard, a capability of a UE, or a type of grant included in the PDCCH.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of an identification component 1208 or a determination component 1210, among other examples.

In some aspects, the apparatus 1200 may be configured to perform one or more operations described herein in connection with FIGS. 5-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive, via a CORESET, a PDCCH transmission including a DMRS. The transmission component 1204 may transmit data indicating a signal quality difference between a first signal quality measurement associated with the DMRS and a most recent signal quality measurement associated with the CORESET.

The identification component 1208 may identify, based at least in part on the DCI including a downlink grant and using an enhanced CSI triggering list, uplink resources.

The determination component 1210 may determine, based on DCI included in the PDCCH, that the DMRS is for the subset of the CORESET resources.

The determination component 1210 may determine, based on DCI included in the PDCCH, that the DMRS is for all resource element groups within the CORESET.

The determination component 1210 may determine that one or more conditions for transmission of the data have been satisfied.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150) may include a beam management component 1308, among other examples.

In some aspects, the apparatus 1300 may be configured to perform one or more operations described herein in connection with FIGS. 5-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network entity described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network entity described in connection with FIG. 2. In some aspects, the transmission component 1304 may be co-located with the reception component 1302 in a transceiver.

The transmission component 1304 may transmit, via a CORESET, a PDCCH transmission including a DMRS. The reception component 1302 may receive data indicating a signal quality difference between a first signal quality measurement associated with the DMRS and a most recent signal quality measurement associated with the CORESET.

The beam management component 1308 may perform one or more beam refinement procedures based at least in part on the signal quality difference.

The transmission component 1304 may transmit configuration information that indicates one or more conditions for transmission of the data.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: receiving, via a CORESET, a PDCCH transmission including a DMRS; and transmitting data indicating a signal quality difference between a first signal quality measurement associated with the DMRS and a most recent signal quality measurement associated with the CORESET.

Aspect 2: The method of Aspect 1, wherein the most recent signal quality measurement is for a most recent type-D quasi co-located source reference signal associated with the CORESET.

Aspect 3: The method of any of Aspects 1-2, wherein transmitting the data comprises: transmitting the data based at least in part on DCI included in the PDCCH.

Aspect 4: The method of Aspect 3, wherein transmitting the data comprises: transmitting the data in a PUSCH transmission scheduled by the DCI.

Aspect 5: The method of Aspect 3, further comprising: identifying, based at least in part on the DCI including a downlink grant and using an enhanced CSI triggering list, uplink resources; and wherein transmitting the data comprises: transmitting the data using the uplink resources. wherein transmitting the data comprises: transmitting the data using the uplink resources.

Aspect 6: The method of any of Aspects 1-5, wherein transmitting the data comprises: transmitting the data based at least in part on an enhanced CSI report setting associated with an aperiodic CSI triggering list.

Aspect 7: The method of any of Aspects 1-6, wherein the DMRS associated with the first signal quality measurement is for a subset of the CORESET resources that includes resource element groups that correspond to the PDCCH.

Aspect 8: The method of Aspect 7, further comprising: determining, based on DCI included in the PDCCH, that the DMRS is for the subset of the CORESET resources.

Aspect 9: The method of Aspect 8, wherein the determination is based at least in part on at least one of: an aggregation level associated with the PDCCH satisfying an aggregation threshold, or an indication, included in the DCI, specifying that the DMRS is for the subset of the CORESET resources.

Aspect 10: The method of any of Aspects 1-9, wherein the DMRS associated with the first signal quality measurement corresponds to both PDCCH resources and non-PDCCH resources of the CORESET.

Aspect 11: The method of Aspect 10, further comprising: determining, based on DCI included in the PDCCH, that the DMRS is for all resource element groups within the CORESET.

Aspect 12: The method of Aspect 11, wherein the determination is based at least in part on at least one of: a same precoding being applied to all resource element groups within the CORESET, or an indication, included in the DCI, specifying that the DMRS is for both the PDCCH resources and the non-PDCCH resources.

Aspect 13: The method of any of Aspects 1-12, further comprising: determining that one or more conditions for transmission of the data have been satisfied; and wherein transmitting the data comprises: transmitting the data based at least in part on determining that the one or more conditions have been satisfied. wherein transmitting the data comprises: transmitting the data based at least in part on determining that the one or more conditions have been satisfied.

Aspect 14: The method of Aspect 13, wherein the one or more conditions include at least one of: a time interval between a monitoring occasion of the CORESET and a transmission time for the transmission of the data satisfies a time threshold, and a number of PDCCH transmissions triggering the transmission of the data satisfies a threshold number of PDCCH transmissions within a particular period of time.

Aspect 15: The method of Aspect 14, wherein at least one of the time interval, the threshold number, or the particular period of time, is based at least in part on at least one of: a predefined standard, a capability of the UE, or a type of grant included in the PDCCH.

Aspect 16: A method of wireless communication performed by a network entity, comprising: transmitting, via a CORESET, a PDCCH transmission including a DMRS; and receiving data indicating a signal quality difference between a first signal quality measurement associated with the DMRS and a most recent signal quality measurement associated with the CORESET.

Aspect 17: The method of Aspect 16, further comprising: performing one or more beam refinement procedures based at least in part on the signal quality difference.

Aspect 18: The method of any of Aspects 16-17, wherein the PDCCH includes DCI that triggers transmission of the signal quality difference.

Aspect 19: The method of Aspect 18, wherein the DCI includes an uplink grant scheduling a PUSCH transmission; and receiving the data comprises: receiving the data in the PUSCH transmission.

Aspect 20: The method of Aspect 18, wherein the DCI includes a downlink grant; and wherein receiving the data comprises: receiving the data using uplink resources configured for reception of the data.

Aspect 21: The method of any of Aspects 16-20, wherein the DMRS associated with the first signal quality measurement is for a subset of the CORESET resources that includes resource element groups that correspond to the PDCCH.

Aspect 22: The method of any of Aspects 16-21, wherein DCI included in the PDCCH indicates that the DMRS is for a subset of the CORESET resources.

Aspect 23: The method of Aspect 22, wherein the DCI indicates that the DMRS is for the subset of the CORESET resources based at least in part on at least one of: an aggregation level associated with the PDCCH and a preconfigured aggregation threshold, or an indication, included in the DCI, specifying that the DMRS is for the subset of the CORESET resources.

Aspect 24: The method of any of Aspects 16-23, wherein the most recent signal quality measurement is a most recent type-D quasi co-located source reference signal associated with the CORESET.

Aspect 25: The method of Aspect 24, wherein DCI included in the PDCCH indicates that the DMRS is for all resource element groups within the CORESET.

Aspect 26: The method of Aspect 25, wherein the DCI indicates that the DMRS is for both the PDCCH resources and the non-PDCCH resources based at least in part on at least one of: a same precoding being applied to all resource element groups within the CORESET, or an indication, included in the DCI, specifying that the DMRS is for both the PDCCH resources and the non-PDCCH resources.

Aspect 27: The method of any of Aspects 16-26, further comprising: transmitting configuration information that indicates one or more conditions for transmission of the data.

Aspect 28: The method of Aspect 27, wherein the one or more conditions include at least one of: a time interval between a monitoring occasion of the CORESET and a transmission time for the transmission of the data satisfies a time threshold, and a number of PDCCH transmissions triggering the transmission of the data satisfies a threshold number of PDCCH transmissions within a particular period of time.

Aspect 29: The method of Aspect 28, wherein at least one of the time interval, the threshold number, or the particular period of time, is based at least in part on at least one of: a predefined standard, a capability of a UE, or a type of grant included in the PDCCH.

Aspect 30: An apparatus for wireless communication at a device, comprising a processor; memory coupled with the processor; and instructions stored in the memory and executable by the processor to cause the apparatus to perform the method of one or more of Aspects 1-15.

Aspect 31: An apparatus for wireless communication at a device, comprising a processor; memory coupled with the processor; and instructions stored in the memory and executable by the processor to cause the apparatus to perform the method of one or more of Aspects 16-29.

Aspect 32: A device for wireless communication, comprising a memory and one or more processors coupled to the memory, the one or more processors configured to perform the method of one or more of Aspects 1-15.

Aspect 33: A device for wireless communication, comprising a memory and one or more processors coupled to the memory, the one or more processors configured to perform the method of one or more of Aspects 16-29.

Aspect 34: An apparatus for wireless communication, comprising at least one means for performing the method of one or more of Aspects 1-15.

Aspect 35: An apparatus for wireless communication, comprising at least one means for performing the method of one or more of Aspects 16-29.

Aspect 36: A non-transitory computer-readable medium storing code for wireless communication, the code comprising instructions executable by a processor to perform the method of one or more of Aspects 1-15.

Aspect 37: A non-transitory computer-readable medium storing code for wireless communication, the code comprising instructions executable by a processor to perform the method of one or more of Aspects 16-29.

Aspect 38: A non-transitory computer-readable medium storing a set of instructions for wireless communication, the set of instructions comprising one or more instructions that, when executed by one or more processors of a device, cause the device to perform the method of one or more of Aspects 1-15 .

Aspect 39: A non-transitory computer-readable medium storing a set of instructions for wireless communication, the set of instructions comprising one or more instructions that, when executed by one or more processors of a device, cause the device to perform the method of one or more of Aspects 16-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, via a control resource set (CORESET), a physical downlink control channel (PDCCH) transmission including a demodulation reference signal (DMRS); and
transmit data indicating a signal quality difference between a first signal quality measurement associated with the DMRS and a most recent signal quality measurement associated with the CORESET.

2. The UE of claim 1, wherein the most recent signal quality measurement is for a most recent type-D quasi co-located source reference signal associated with the CORESET.

3. The UE of claim 1, wherein the one or more processors, to transmit the data, are configured to:
transmit the data based at least in part on downlink control information (DCI) included in the PDCCH.

4. The UE of claim 3, wherein the one or more processors, to transmit the data, are configured to:
transmit the data in a physical uplink shared channel (PUSCH) transmission scheduled by the DCI.

5. The UE of claim 3, wherein the one or more processors are further configured to:
identify, based at least in part on the DCI including a downlink grant and using an enhanced channel state information (CSI) triggering list, uplink resources; and
wherein the one or more processors, to transmit the data, are configured to:
transmit the data using the uplink resources.

6. The UE of claim 1, wherein the one or more processors, to transmit the data, are configured to:
transmit the data based at least in part on an enhanced channel state information (CSI) report setting associated with an aperiodic CSI triggering list.

7. The UE of claim 1, wherein the DMRS associated with the first signal quality measurement is for a subset of the CORESET resources that includes resource element groups that correspond to the PDCCH.

8. The UE of claim 7, wherein the one or more processors are further configured to:
determine, based on downlink control information (DCI) included in the PDCCH, that the DMRS is for the subset of the CORESET resources.

9. The UE of claim 8, wherein the determination is based at least in part on at least one of:
an aggregation level associated with the PDCCH satisfying an aggregation threshold, or
an indication, included in the DCI, specifying that the DMRS is for the subset of the CORESET resources.

10. The UE of claim 1, wherein the DMRS associated with the first signal quality measurement corresponds to both PDCCH resources and non-PDCCH resources of the CORESET.

11. The UE of claim 10, wherein the one or more processors are further configured to:
determine, based on downlink control information (DCI) included in the PDCCH, that the DMRS is for all resource element groups within the CORESET.

12. The UE of claim 11, wherein the determination is based at least in part on at least one of:
a same precoding being applied to all resource element groups within the CORESET, or
an indication, included in the DCI, specifying that the DMRS is for both the PDCCH resources and the non-PDCCH resources.

13. The UE of claim 1, wherein the one or more processors are further configured to:
determine that one or more conditions for transmission of the data have been satisfied; and
wherein the one or more processors, to transmit the data, are configured to:
transmit the data based at least in part on determining that the one or more conditions have been satisfied.

14. The UE of claim 13, wherein the one or more conditions include at least one of:
a time interval between a monitoring occasion of the CORESET and a transmission time for the transmission of the data satisfies a time threshold, and a number of PDCCH transmissions triggering the transmission of the data satisfies a threshold number of PDCCH transmissions within a particular period of time.

15. The UE of claim 14, wherein at least one of the time interval, the threshold number, or the particular period of time, is based at least in part on at least one of:
a predefined standard,
a capability of the UE, or
a type of grant included in the PDCCH.

16. A network entity for wireless communication, comprising:
a memory; and
one or more processors, coupled to the memory, configured to:
transmit, via a control resource set (CORESET), a physical downlink control channel (PDCCH) transmission including a demodulation reference signal (DMRS); and
receive data indicating a signal quality difference between a first signal quality measurement associated with the DMRS and a most recent signal quality measurement associated with the CORESET.

17. The network entity of claim 16, wherein the one or more processors are further configured to:
perform one or more beam refinement procedures based at least in part on the signal quality difference.

18. The network entity of claim 16, wherein the PDCCH includes downlink control information (DCI) that triggers transmission of the signal quality difference.

19. The network entity of claim 18, wherein the DCI includes an uplink grant scheduling a physical uplink shared channel (PUSCH) transmission; and
receive the data comprises:
receive the data in the PUSCH transmission.

20. The network entity of claim 18, wherein the DCI includes a downlink grant; and
wherein the one or more processors, to receive the data, are configured to:
receive the data using uplink resources configured for reception of the data.

21. The network entity of claim 16, wherein the DMRS associated with the first signal quality measurement is for a subset of the CORESET resources that includes resource element groups that correspond to the PDCCH.

22. The network entity of claim 16, wherein downlink control information (DCI) included in the PDCCH indicates that the DMRS is for a subset of the CORESET resources.

23. The network entity of claim 22, wherein the DCI indicates that the DMRS is for the subset of the CORESET resources based at least in part on at least one of:
an aggregation level associated with the PDCCH and a preconfigured aggregation threshold, or
an indication, included in the DCI, specifying that the DMRS is for the subset of the CORESET resources.

24. The network entity of claim 16, wherein the most recent signal quality measurement is a most recent type-D quasi co-located source reference signal associated with the CORESET.

25. The network entity of claim 24, wherein downlink control information (DCI) included in the PDCCH indicates that the DMRS is for all resource element groups within the CORESET.

26. The network entity of claim 25, wherein the DCI indicates that the DMRS is for both the PDCCH resources and the non-PDCCH resources based at least in part on at least one of:
a same precoding being applied to all resource element groups within the CORESET, or
an indication, included in the DCI, specifying that the DMRS is for both the PDCCH resources and the non-PDCCH resources.

27. The network entity of claim 16, wherein the one or more processors are further configured to:
transmit configuration information that indicates one or more conditions for transmission of the data.

28. The network entity of claim 27, wherein the one or more conditions include at least one of:
a time interval between a monitoring occasion of the CORESET and a transmission time for the transmission of the data satisfies a time threshold, and
a number of PDCCH transmissions triggering the transmission of the data satisfies a threshold number of PDCCH transmissions within a particular period of time.

29. A method of wireless communication performed by a user equipment (UE), comprising:
receiving, via a control resource set (CORESET), a physical downlink control channel (PDCCH) transmission including a demodulation reference signal (DMRS); and
transmitting data indicating a signal quality difference between a first signal quality measurement associated with the DMRS and a most recent signal quality measurement associated with the CORESET,
wherein the most recent signal quality measurement is for a most recent type-D quasi co-located source reference signal associated with the CORESET.

30. A method of wireless communication performed by a network entity, comprising:
transmitting, via a control resource set (CORESET), a physical downlink control channel (PDCCH) transmission including a demodulation reference signal (DMRS); and
receiving data indicating a signal quality difference between a first signal quality measurement associated with the DMRS and a most recent signal quality measurement associated with the CORESET.
